(19) United States
(12) Patent Application Publication
(10) Pub. No.: US 2013/0103488 A1
(43) Pub. Date: Apr. 25, 2013

(54) Gas nozzle advertising platform

(71) Applicant: Christopher Orloff, Miami, FL (US)

(72) Inventor: Christopher Orloff, Miami, FL (US)

(21) Appl. No.: 13/317,513

(22) Filed: Oct. 21, 2011

(51) Int. Cl. G09F 15/00; G06Q 30/02; G09F 7/12

(52) U.S. Cl. 705/14.39; 40/606.03; 40/594

(57) ABSTRACT

An advertising device is provided which can be affixed to a nozzle for dispensing liquid products, such as a gasoline dispensing nozzle of a gasoline pump. This advertising device has a display platform and means for releasable attachment to the gasoline pump nozzle. The information depicted upon the advertising platform can included both text and graphic information, the latter being scannable by a smart phone or comparable device, to thereby direct the customer to the web site of the advertiser.

### BACKGROUND OF THE INVENTION

1. Field of the Invention

This invention relates to an article of manufacturer. More specifically, is invention is directed to a device for displaying advertising, which can be affixed to a nozzle for dispensing liquid products, such as a gasoline. This device includes means for releasable attachment of a display platform to the gasoline dispensing nozzle, and to the information which is displayed on such platform.

2. Description of the Prior Art

The use of a display for advertising of products, which is associated with dispensing of products, such as gasoline, is well-known. Generally, such displays can be integrated into the dispensing assembly, and/or be located remotely from the dispensing assembly. In the latter instance, the display includes some means for association of the display with the dispensing assembly, or in proximate relation to the dispensing assembly.

In the advertising or informational displays associated with the dispensing of gasoline, such display devices can be associated with the gas pump console, the hose (which extends from the gas pump console to a dispensing nozzle), and/or with the gas pump dispensing nozzle itself. In each instance, the advertising display includes a graphic or informational message, which is directed to the consumer of the gasoline product.

Typically, the refiner or gas station operator includes its own information, which is related to the product being purchased/dispensed and/or a promotional message, geared to its other products, hereinafter also “In-House Advertising”. Such In-House Advertising is generally placed at location which is remote from the dispensing nozzle, and is thematic, in that it reflects the gasoline products origin and/or the service station, at which it is being sold.

More recently, a series of advertising devices have been disclosed which attempt to exploit the frequent contact of the public with the periodic purchase of gasoline. The gradual emergence of this venue for promotion of products and services, which are unrelated to the station owner, or the source of the gasoline, is the result of the essentially complete transition of the gasoline stations from a full service station environment, to an environment which is dominated by self-service gasoline pumps. With this transition, has come the realization that the consumer is now a captive audience for advertising and promotional materials while awaiting/attending to the filling of vehicle with gasoline at the gas pump.

Gas Pump Hose Advertising Devices

These advertising devices have typically. taken the form of a frame or panel, which can be attached to the hose of the gasoline pump. U.S. Pat. No. 6,233,858 (to Brach et al—issued May 22, 2001), and US Pat. Pub. No. 2005/0060924 (to Feucht et al—published Mar. 24, 2005), are representative of such gas pump hose advertising devices.

The advertising device described by Brach in his '858 patent includes a frame with a slide located on one edge thereof, that can be slid into a slide housing located on a hose connector collar. The hose connector collar of the Brach device is connected to the gas pump hose by a clamp located at opposite ends of the hose connector collar. Advertising structure/media is placed within the frame and preferable at eye level of a customer of the service station, to maximize the effect of the advertisement while the customer is at the service station.

The advertising device described by Feucht in patent publication '924 comprises a cylindrically shaped foam insert designed for placement on the hose of a gas pump. This cylindrically shaped foam insert is further provided with a covering adapted to at least substantially cover the foam insert. This covering is the medium for advertising display.

Gas Pump Nozzle Advertising Devices

An alternative form advertising device for the gas pump dispensing environment contemplate the modification/redesign of the so-called “scuff guard”, which is associated with and covers the gasoline dispensing nozzle. U.S. Pat. No. 4,465,209 (to Wilder—issued Aug. 14, 1984) and US Pat. Pub. No. 2004/0221920 (to Ferguson et al—published Nov. 11, 2004) are representative of such gas pump nozzle advertising devices.

The advertising device described by Wilder describes an information center for gasoline dispensing nozzles which utilizes a molded plastic disc associated with the scuff guard of the gasoline dispensing nozzle. In brief, Wilder contemplate modification of the scuff guard by removing a portion of the scuff guard to form a top message surface on the nozzle. He thereafter attaches a molded plastic disc to this modified area of the scuff guard. This molded plastic disc has a central body portion which extends through the modified area (hole) of snug-fitting scuff guard of a gasoline nozzle. A flange about the lower surface of the disc entraps the disc between the scuff guard and the nozzle, so that the disc is retained easily, without the need for fasteners or tools. Informative advertising is applied to the top exposed surface of the disc by means of pressure sensitive labels, silk screen printing, molded letters and logos, and the like.

The advertising device described by Ferguson et al comprise a gasoline dispensing nozzle wherein the traditional scuff guard on the nozzle has been replaced with nozzle assembly, which includes an electrically powered, information center integrated into the scuff guard. The Ferguson thus contemplates the real-time or periodic display of information via this electrically powered, alpha numeric display, which in integral to the nozzle scuff guard assembly.

As is now evident from the foregoing discussion, the use of advertising in association with the dispensing of gasoline has generally been limited to either the addition of device to the gasoline hose, or the physical modification of the scuff guard associated the dispensing nozzle at moderate to considerable expense to the gasoline station operator. In the case of the advertising associated with the gasoline hose, the advertising display must be placed at a location on the hose with is remote from the nozzle to prevent inadvertent contact of the display with the surface of the vehicle, to prevent scratching of the vehicle paint; or, alternatively constructing such device from of a soft foam material, to avoid scratching the vehicle surface in the event of contact of such device with the surface of the vehicle.

In the case of the advertising associated with gasoline dispending nozzle, invariably such advertising devices up to now have required some modification of the existing scuff guard on the gasoline dispensing nozzle, of the replacement of the scuff guard with a new scuff guard which has been modified with the advertising platform built in. In the latter instance, the modification and/or replacement of the scuff guard is expensive and disruptive to the operation of service station when such modification is being performed

Accordingly, there continues to exist a need for a simple, yet effective means for the placement of an advertising message on the gasoline pump, preferably on or proximate to the gasoline dispensing nozzle, which does not require replacement or modification of the scuff of such nozzle, and yet does not suffer from the limitations and shortcoming of the devices commonly adapted for advertising devices associated with the gasoline hoses.

### OBJECTIVES OF THIS INVENTION

It is the object of this invention to remedy the above as well as related deficiencies in the prior art.

More specifically, it is the principle object of this invention to provide a advertising device for releasable attachment of an advertising medium to a fluid dispensing nozzle, which includes a media surface or platform for the display of information unrelated to the product being dispensed.

It is another object of this invention to provide an advertising device for attachment to a fluid dispensing nozzle for display of information at the point of sale of fluid products, such as gasoline, from such fluid dispensing nozzle.

It is yet another object of this invention to provide an advertising device for attachment to a fluid dispensing nozzle for display of information on the nozzle of a gasoline pump, without modification of the scuff guard on the nozzle.

It is still yet another object of this invention to provide an advertising device for attachment to a fluid dispensing nozzle for display of information on the nozzle of a gasoline pump by means of a releasable coupling.

Additional objects of this invention include the addition of a graphic and/or a pictorial image to the advertising media, which is scanable by a smart phone, and thereby directs the customer to the web site of the advertiser.

### SUMMARY OF THE INVENTION

The above and related objects are achieved by providing an advertising device for displaying advertising, which can be affixed to a nozzle for dispensing liquid products, such as a gasoline pump nozzle. This advertising device includes means for releasable attachment of a display platform of such device to the gasoline dispensing nozzle, and the information displayed on such platform.

In the preferred embodiments of this invention, the device comprises an assembly having (a) a advertising platform with planar surface for display of graphic, and alpha numeric information, and (b) means, on at least one end of said advertising platform, for releasable attachment of the advertising platform, to the nozzle of a gasoline pump. In practice, the operational constraints of the nozzle of the gasoline pump limit the shape of the advertising platform, the positioning of the advertising platform on the nozzle and the means for attachment of the advertising platform to the nozzle. Accordingly, the advertising platform is preferably an elongate, generally rectangular body, with a taper on the proximal end thereof. In the preferred embodiments of this invention, the advertising platform is attached to the dispensing nozzle at this proximal end.

The means from attachment of the proximal end of the advertising platform can include a simple plastic electrical tie or metal wire, which is threaded through the a series of apertures on the proximal end of advertising platform; or, such attachment means can comprise a more elaborate coupling means (e.g. collar or molded clamp) integrated into and/or formed as a component on the proximal end the advertising platform.

It is also contemplated that the graphics and/or alpha numeric information, which is displayed on the advertising platform, are functional so as to provide not only point of sale advertising (e.g. name of the product and its features), but also a graphic, in the form of a QR code, (abbreviated from Quick Response code), which is a specific matrix barcode (or two-dimensional code). The QR code consists of black modules arranged in a square pattern on a white background. The information encoded may be text, URL, or other data. The QR code is scannable by a QR reader, smart phone, or other comparable device, to link the consumer to the advertiser's web site for additional product information, including the downloading of coupons and other incentives, (e.g. promotional codes), for obtaining discounts on future purchases.

### BRIEF DESCRIPTION OF DRAWINGS

FIG. 1 depicts a perspective view of the advertising assembly of this invention.

FIG. 2 depicts a perspective view of the advertising assembly of this invention FIG. 1, as installed on the nozzle of a gasoline pump.

FIG. 3 depicts a perspective view of the advertising assembly of this invention FIG. 2, during the operation of the nozzle of the gasoline pump.

FIG. 4 depicts a perspective view of the advertising assembly of this invention FIG. 1, as installed on the base of the nozzle of the gasoline pump.

FIG. 5 depicts an enlarged view of the means of coupling the advertising assembly to the base of the nozzle of the gasoline pump.

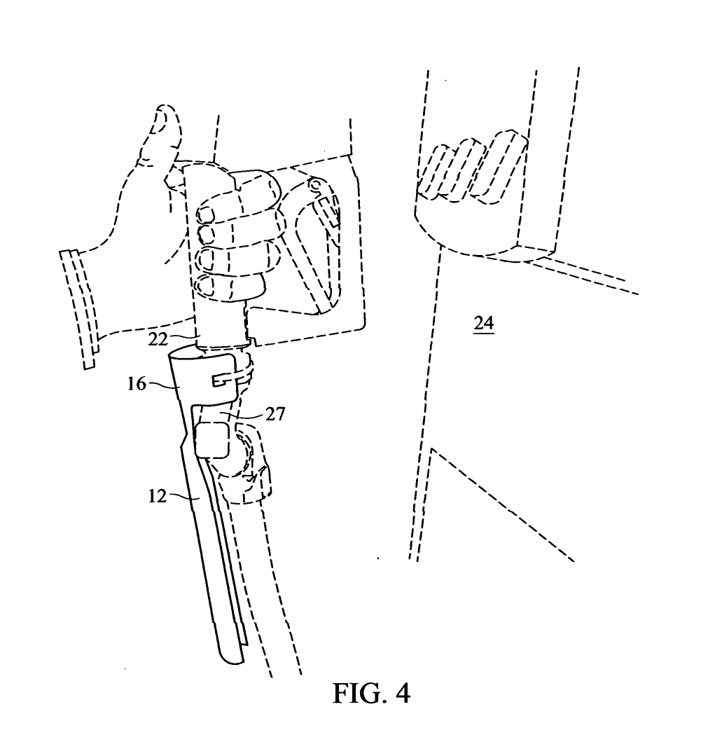

### DESCRIPTION OF THE INVENTION INCLUDING PREFERRED EMBODIMENTS

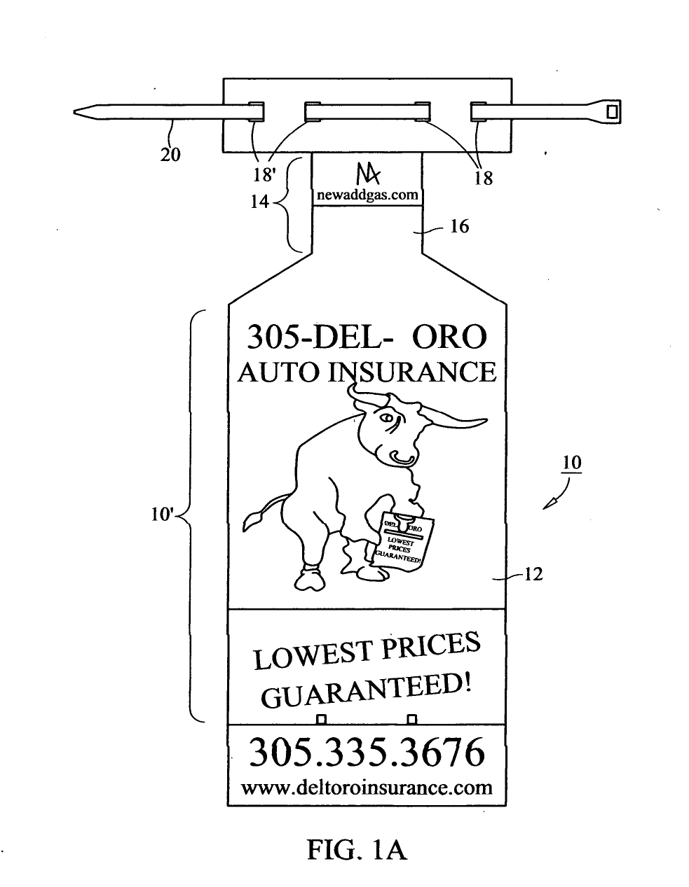

The advertising assembly of this invention is depicted in FIG. 1, when viewed from the front (FIG. 1A) and from the back (FIG. 1B). This advertising assembly (10) includes an essentially planar surface, or platform (12), having a generally elongate shape (12′), and a taper (14) on the proximal end thereof (16). The proximal end (16) of this platform (12) includes, in the preferred embodiments of this invention, an array of apertures (18, 18′) which have been pre-positioned to accommodate a fastener (20) for attachment of the advertising assembly (10) to the nozzle (22) of a gasoline pump (24). In the preferred embodiments of this invention, the backside of the advertising assembly (10) has a piece of double sided adhesive tape (25) on the underside of the proximal end (16) of the advertising assembly (10). The exposed surface of this adhesive tape is provided with a peal-away protective cover (25′). When the advertising assembly (10) is ready for attachment to the nozzle (22), the peal-away protective cover (25′) is removed from the tape, and the advertising assembly (10) attached to the nozzle (22), with a suitable fastener. The proximal end (16) of the advertising assembly (10) is then pressed against the contiguous surface of the nozzle, thereby creating an adhesive bond between the adhesive tape (25) and the opposing contiguous surface of the nozzle (22). When the advertising assembly (10) is to be removed from the nozzle (22), the fasteners (18, 18′) are disengaged, and the adhesive tape (25) releases from the nozzle (22) by simply pulling the advertising assembly (10) away from the nozzle.

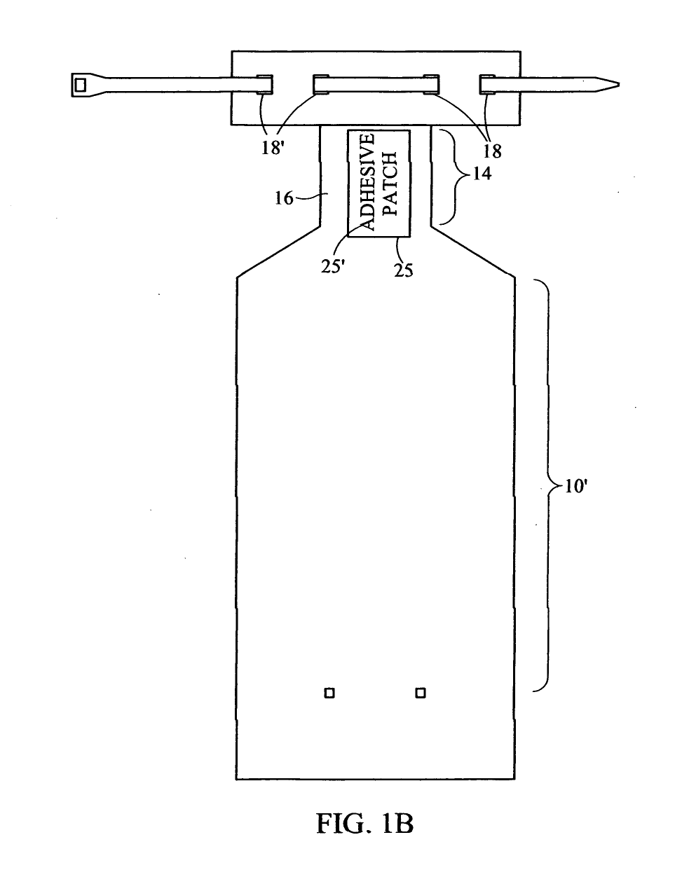

FIG. 2 depicts the advertising assembly (10) of FIG. 1, as affixed to the nozzle (22) of a gasoline pump (24). In the embodiment of this invention depicted in FIG. 2, the proximal end (16) of the display platform (12) is attached to the nozzle (22), by means of a plastic electrical tie (20). In one of the alternative embodiments of this invention, the proximal end (16) of the display platform (12) can be shaped or pre-formed to conform to the contours of the nozzle (22) at the point of attachment, to prevent slippage or relative movement of the advertising assembly (10), after it is affixed to the nozzle (22). Alternatively, slip resistant means can be provided on the surface of the nozzle (22) to prevent relative movement of the advertising assemble (10) after it has been attached to the nozzle.

As above noted, in an alternative embodiment of this invention, the advertising assembly (10) is further provided with a weather resistant adhesive surface (25), on the underside of the proximal end (16) of the advertising device (10), to prevent relative movement of the display platform (12) after it has been attached to the nozzle (22). Additional fasteners and/or strips of double sided adhesive tape, can be located in additional and/or alternative locations on the advertising assembly (10) depending upon the size and shape of the nozzle to which attachment is contemplated.

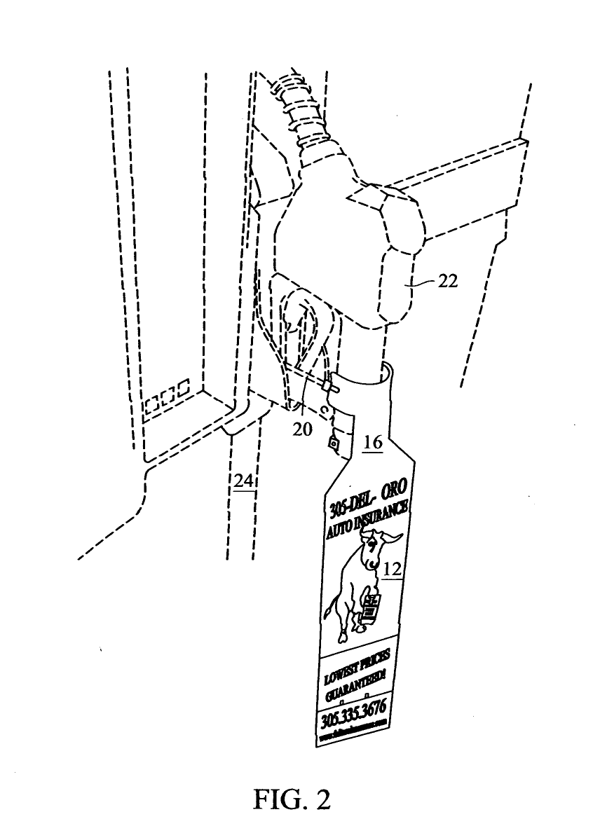

FIG. 3 depicts the nozzle (22), with the advertising assembly (10) attached, in operation during the fueling of an automobile. The advertising assembly (10) is prominently displayed during the re-fueling process. In this depiction, the advertising assembly (10) displaced sufficiently from the hand grip of the nozzle so as not to interfere with the operation of the nozzle, yet remote from the surface of the vehicle so as not to scratch the painted surface thereof.

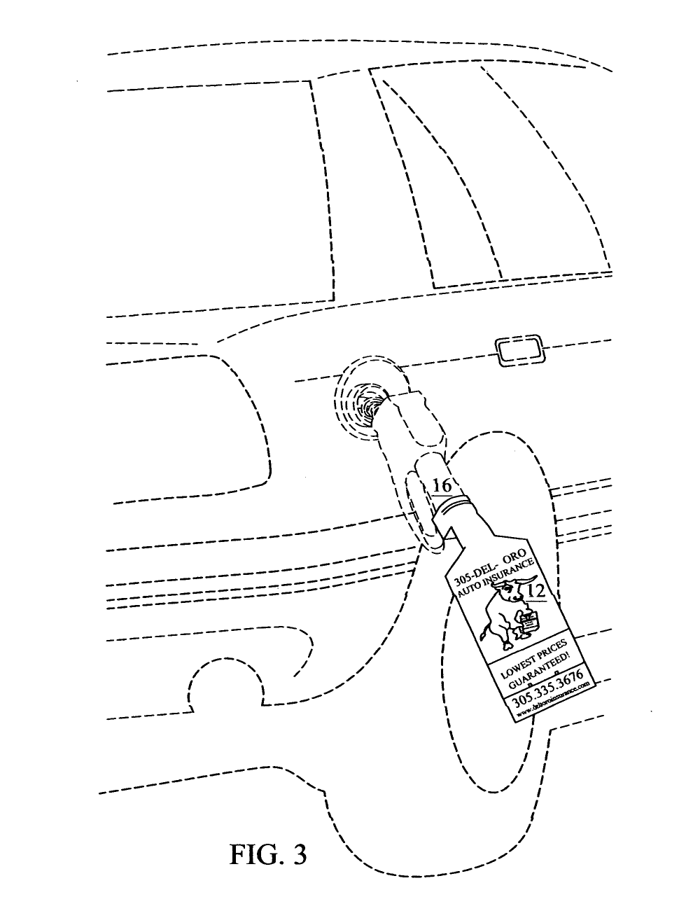

FIG. 4 depicts the use of an articulating connector (27) to connect the nozzle (22) to the hose of the gasoline pump (24). In this embodiment of the invention, the advertising assembly (10) is attached to articulating connector (27) is essentially the same manner as described above in the description of FIG. 3. Alternatively, slip resistant means can be provided on the surface of the articulating connector (27) to prevent relative movement of the advertising assemble (10) after it has been attached to the articulating connector (27) of the nozzle (22).

What is claimed is:

1. In an advertising assembly adapted for use in conjunction with the fluid dispensing of a consumer products from a source of fluid equipped with a pump, a hose and a dispensing nozzle, wherein said fluid is dispensed, under pressure, from said source through a hose, and the flow of said fluid from said hose is controlled by a hand operated nozzle, wherein the improvement comprises:
A. An advertising assembly comprising a platform having an essentially planar surface, and an essentially asymmetric two dimensional shape, said asymmetric two dimensional shape of said platform having a proximal end and a distal end,
wherein said proximal end of said platform is tapered so as to correspond, at least in part, with a hand grip of said hand operated nozzle, and having means for attachment of said proximal end of said platform to said hand grip of said nozzle.

2. The improved advertising assembly of claim 1, wherein said means for attachment of said proximal end of said platform to said hand grip of said nozzle includes an array of apertures in said proximal end of said platform and at least one fastening means, wherein said fastening means is adapted for attachment of said proximal end of said platform, through said apertures, to said hand grip of said nozzle.

3. The improved advertising assembly of claim 2, wherein said proximal end of said platform includes a weather resistant adhesive material to adhere said proximal end of said platform to said hand grip of said nozzle upon pressure contact of said proximal end of said platform to said hand grip.

4. The improved advertising assembly of claim 3, wherein said weather resistant adhesive material comprises a piece of double-sided adhesive tape.

5. The improved advertising assembly of claim 3, wherein said weather resistant adhesive material comprises a silicone based sealant or caulk.

6. The improved advertising assembly of claim 2, wherein said platform includes graphic in the form of a Quick Response code (QR code), said Quick Response being scannable by a QR code reader or smart cellular phone, and thereby link said QR code reader or smart cellular phone to an advertiser's web site for additional product information, including downloading of coupons and other promotional incentives, for obtaining discounts on purchases from said advertiser.
